(19) United States
(12) Patent Application Publication
(10) Pub. No.: US 2011/0090148 A1
(43) Pub. Date: Apr. 21, 2011

(54) Wearable input device

(75) Inventors: Sheau-Lin Li, Taipei (TW); Tsu-Nan Lee, Taipei (TW); Chih-Min Liu, Taipei (TW)

(73) Assignee: KYE SYSTEMS CORP., San Chung City (TW)

(21) Appl. No.: 12/654,785

(22) Filed: Jan. 4, 2010

(30) Foreign Application Priority Data
Oct. 21, 2009 (TW) 098135678

(51) Int. Cl. G09G 5/00

(52) U.S. Cl. 345/158

(57) ABSTRACT

A wearable input device includes a body and a soft battery. The body is connected to the soft battery to form a collar range, and the soft battery surrounds a hand of a user. The soft battery supplies an electric power to a finger-contact control module and a wireless transmitter in the body, such that the finger-contact control module senses a movement of an object (for example, a finger) on the body, and generates a control signal corresponding to a moving position of the object, and then the wireless transmitter transmits the control signal to a computer host, thus manipulating a cursor on an operating system frame of the computer host.

### CROSS-REFERENCE TO RELATED APPLICATIONS

This non-provisional application claims priority under 35 U.S.C. §119(a) on Patent Application No(s). 098135678 filed in Taiwan, R.O.C. on Oct. 21, 2009, the entire contents of which are hereby incorporated by reference.

### BACKGROUND OF THE INVENTION

1. Field of the Invention

The present invention relates to an input device, and more particularly to a wearable input device.

2. Related Art

Usually, a mouse is mainly used to replace direction keys on a keyboard to move a cursor, and finishes input manipulations such as positioning, clicking, and dragging, such that the mouse is an indispensable standard configuration for the windows operating system. The current mouse approximately includes a hand-heldable case and a rolling ball sensing structure or an optical sensing structure disposeg.3d on a bottom of the case, so as to transmit a moving signal corresponding to the case to a computer host. Further, two to three input buttons (so-called a left key, a right key, and a middle key of the mouse) are disposed on a top of the case. A user usually holds the mouse with the palm, manipulates the moving of the mouse through a force of the wrist to control a position of the cursor on an operating system frame, and controls whether to press the input button (that is, the left key or the right key) with a fore finger and a middle finger, thereby completing the required instruction input condition.

Further, along with the emergence of portable notebook computers, a trend of light, thin, short, and small becomes a target of the notebook computers, and therefore, the mouse having a size as that of the palm is not applicable to the notebook computers. However, the mouse cannot be omitted in many application programs, so a track ball or a touch pad replacing the mouse is arranged on the notebook computer. However, the track ball or the touch pad is controlled by a direct contact of a finger, and the human finger is not an absolute spherical surface, such that the track ball or the touch pad is less flexible as the mouse in terms of manipulability and usability.

Therefore, in related arts, the mouse is designed to be a finger control structure. For example, in ROC Patent Application No. 443542, a finger control mouse is disclosed, the user needs to put the finger in a finger cot, moves the finger tip to the required position, and presses the input key on one side. However, in this structural design, the moving of the finger is easily limited to a wire. In another conventional art, for example, ROC Patent Application No. 549551, an electronic device having a single finger control key is disclosed. A user controls a separate single finger control key through a single finger except for the thumb, but the electronic device is hard to be manipulated and the moving of the finger and the continuity of the operation are easily suspended.

### SUMMARY OF THE INVENTION

In view of the above problems, the present invention is a wearable input device, so as to provide an input device capable of more sensitively and accurately manipulating a cursor without being limited to a using environment for a user.

The present invention provides a wearable input device, which comprises a body and a soft battery. The body has a finger-contact control module and a wireless transmitter disposed therein. The soft battery is connected to the body and forms a collar range. When being used, the soft battery surrounds a hand of a user through the collar range, and the soft battery supplies an electric power for the body, such that the finger-contact control module senses a movement of an object and generates a corresponding control signal, and the wireless transmitter transmits the control signal to a computer host for manipulating a displacement of a cursor.

The present invention has the following efficacies. The device is conveniently worn on the hand of the user, such that the wearable input device having a small volume is easily carried and conveniently used in cooperation with a notebook computer. The wearable input device is manipulated by a finger, such that the cursor is more flexibly moved with a higher moving accuracy. Further, the wearable input device has a small region for sensing a moving position (only a region having a size the same as a finger tip), thus solving the problem of the prior art that a conventional mouse needs a larger manipulation area.

### BRIEF DESCRIPTION OF THE DRAWINGS

The present invention will become more fully understood from the detailed description given herein below for illustration only, and thus are not limitative of the present invention, and wherein:

FIG. 1 is a schematic block diagram of a wearable input device according to the present invention;

FIG. 2 is a schematic outside view of the wearable input device according to the present invention;

FIG. 3 is a schematic side view of the wearable input device according to the present invention;

FIG. 4 is a schematic view of an operation of the wearable input device according to the present invention surrounding a finger;

FIG. 5 is a schematic side view of a soft battery of a wearable input device according to an embodiment of the present invention; and

FIG. 6 is a schematic side view of a soft battery of a wearable input device according to another embodiment of the present invention.

### DETAILED DESCRIPTION OF THE INVENTION

A wearable input device according to the present invention surrounds a hand of a user, for example, the wearable input device surrounds a wrist or a finger of the user, for manipulating a cursor on an operating system frame of a computer host. In the detailed description of the present invention as follows, the accompanying drawings are only used for reference and description, instead of limiting the present invention.

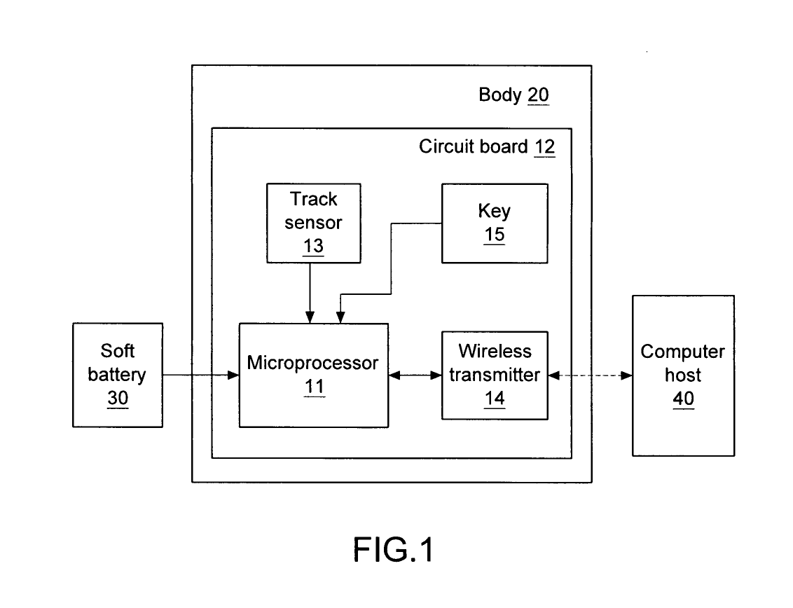

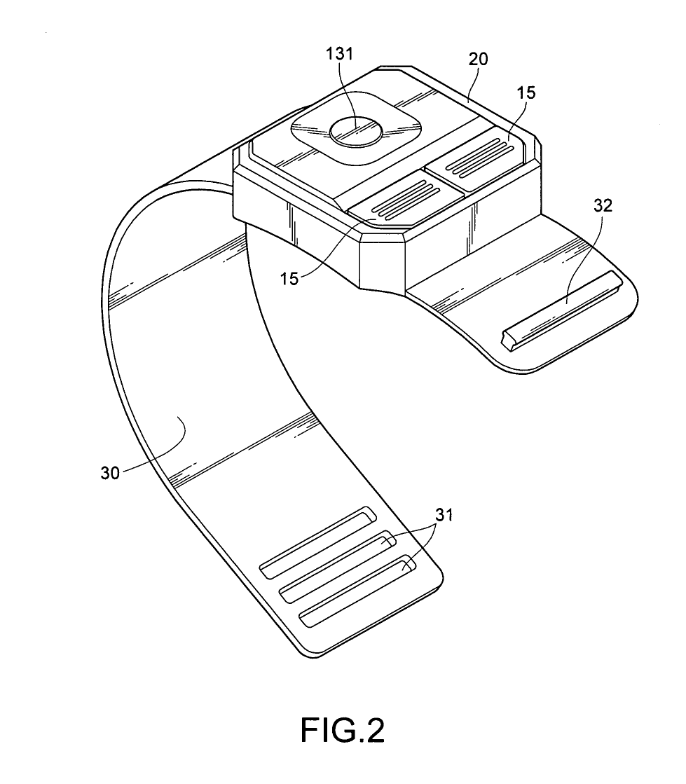

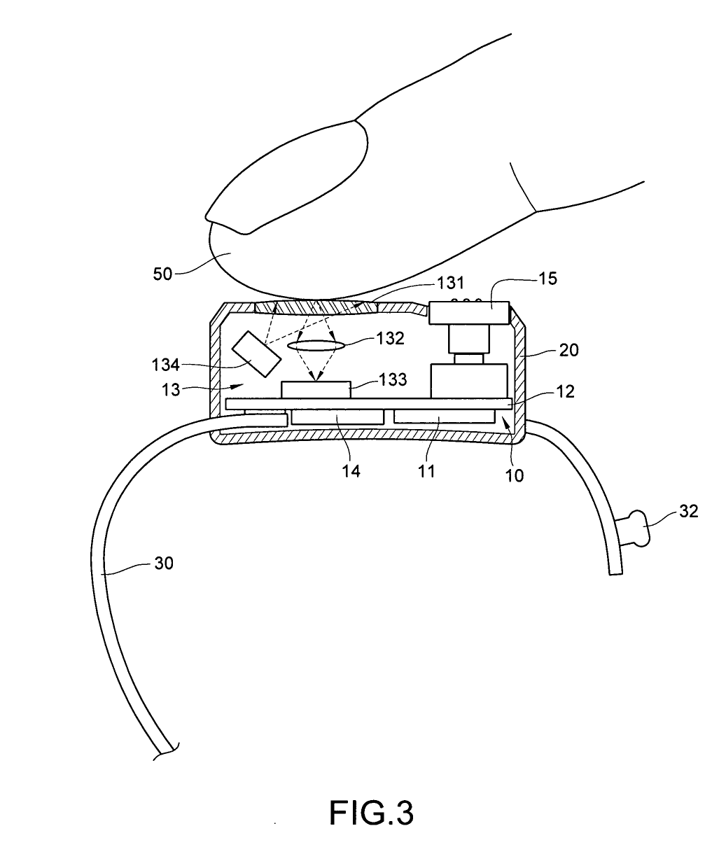

Referring to FIGS. 1 to 3, FIG. 1 is a schematic block diagram of a wearable input device according to the present invention, FIG. 2 is a schematic outside view of the wearable input device according to the present invention, and FIG. 3 is a schematic side view of the wearable input device according to the present invention.

The wearable input device according to the present invention comprises a plurality of functional circuit elements 10, a body 20, and a soft battery 30. The plurality of functional circuit elements 10 of the present invention is installed in the body 20, and at least comprises a microprocessor 11, a circuit board 12, a finger-contact control module 13, a wireless transmitter 14, and a plurality of keys 15.

The microprocessor 11 is electrically disposed on the circuit board 12, and is used to receive a moving signal transmitted by the finger-contact control module 13 and convert the moving signal to a control signal corresponding to the computer host 40 for being transmitted by the wireless transmitter 14.

The finger-contact control module 13 comprises, but not limited to, an optical finger-contact control module, a track ball device, a touch pad device, or other electronic devices having a track sense function. For example, the optical finger-contact control module comprises a light transmissive sheet 131, an imaging lens 132, an optical sensing element 133, and a light emitting element 134. The light transmissive sheet 131 is installed on the body 20, for an object 50 (for example, the finger of the user) to contact with and move on a surface thereof.

The optical sensing element 133 and the light emitting element 134 are electrically disposed on the circuit board 12, and a position of the optical sensing element 133 is made to correspond to a position of the light transmissive sheet 131. The light emitting element 134 is adjacent to a side edge of the optical sensing element 133, and emits a sensing ray to the light transmissive sheet 131. In addition, the imaging lens 132 is disposed between the light transmissive sheet 131 and the optical sensing element 133.

Further, the light transmissive sheet 131 may be a light transmissive plate or a lens made of acrylic or glass, for improving a sensing efficiency of the finger-contact control module 13. The light transmissive sheet 131 may be a biconvex lens, the finger of the user may comfortably moves and operates on the light transmissive sheet 131, and the design of the biconvex lens may assist the imaging of a reflection image of the object 50, thereby greatly reducing the entire height of the finger-contact control module 13.

In addition, the optical sensing element 133 may be a charged coupled device (CCD) or a complementary metal-oxide semiconductor (CMOS). The light emitting element 134 may be a vertically-emitting light emitting diode (LED), a side emitting LED, or other similar light emitting elements, so as to emit the ray having directivity.

The wireless transmitter 14 is electrically disposed on the circuit board 12, for receiving the moving signal transmitted by the microprocessor 11. The wireless transmitter 14 may transmit the moving signal to a computer host 40 in a wireless transmission manner by adopting transmission techniques such as Blue-Tooth transmission, radio frequency (RF) transmission, wireless network transmission, or infrared (IR) transmission, so as to manipulate a displacement direction of the cursor on the operating system frame of the computer host 40.

The plurality of keys 15 is electrically disposed on the circuit board 12, and is exposed out of the body 20. In this embodiment, two keys 15 are provided, which respectively represent a left key and a right key of a mouse, but the present invention is not limited here. Further, the keys 15 generate a key signal when being triggered.

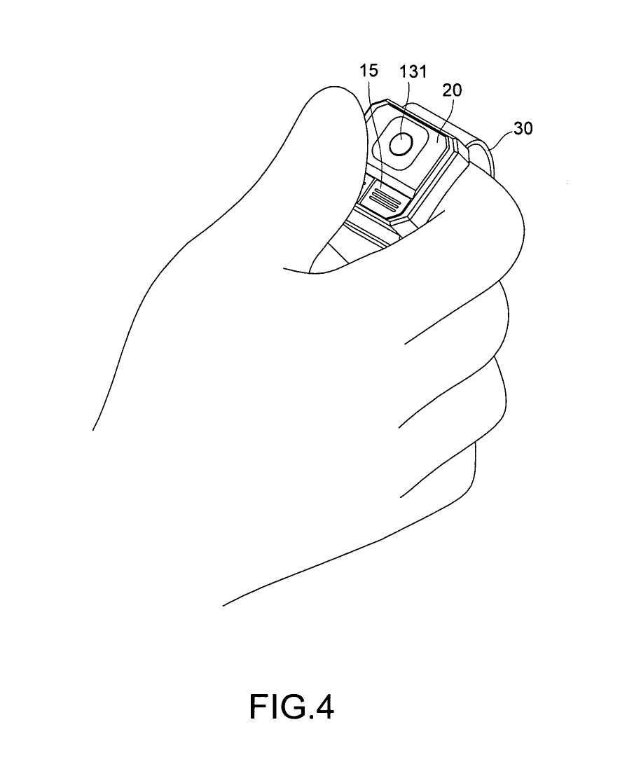

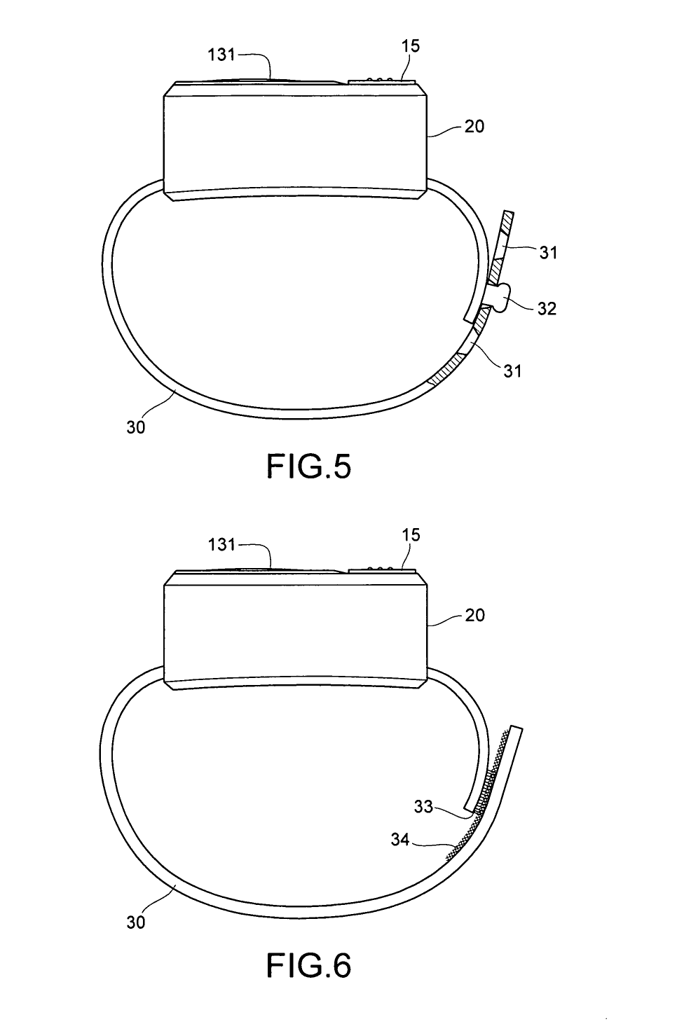

FIG. 4 is a schematic view of an operation of the wearable input device according to the present invention surrounding the finger, and FIG. 5 is a schematic side view of the soft battery of a wearable input device according to an embodiment of the present invention. Referring to FIGS. 4 and 5, the soft battery 30 is formed by laminating a lamination unit at least consisting of a current collector layer, a positive active substance layer, a solid electrolyte layer, and a negative active substance layer for at least two times, and the process of forming the soft battery 30 is a conventional art, so it is not described here. In this manner, the user may connect one end of the soft battery 30 to the body 20, and form a collar range between the other end of the soft battery 30 and the body 20. Further, a positive electrode contact and a negative electrode contact (not shown) are formed on the soft battery 30, such that the positive electrode contact and the negative electrode contact of the soft battery 30 are respectively electrically connected to the functional circuit elements 10 in the body 20, and the soft battery 30 may supply an electric power for each of the functional circuit elements 10.

In this manner, the soft battery 30 may surround the finger. For example, after the soft battery 30 surrounds a fore finger of a right hand, as a buckle hole 31 and a fixing buckle 32 are respectively disposed on the soft battery 30, the fixing buckle 32 is buckled in the buckle hole 31, such that the body 20 is fixed on the fore finger of the user. The buckle hole 31 and the fixing buckle 32 are designed to be far away from the related lamination structure of the soft battery 30. In other words, a connection end without any lamination structure may be extended on two ends of the soft battery 30, such that the connection end is connected to the body 20, and the buckle hole 31 and the fixing buckle 32 are respectively opened on the other end being away from the connection end. In addition, as shown in FIG. 6, a pair of hook-and-loop fasteners 33, 34 is designed on the soft battery 30, after the soft battery 30 surrounds the finger, the hook-and-loop fasteners 33, 34 are adhered to each other, so as to fix the body 20 on the fore finger of the user.

When the device is used, a thumb of the right hand of the user moves on the light transmissive sheet 131 of the finger-contact control module 13 (for example, the optical finger-contact control module), the light emitting element 134 emits a sensing ray to the light transmissive sheet 131, and the sensing ray penetrates the light transmissive sheet 131 and emits out of the body 20, such that the sensing ray is projected to the thumb sliding on the light transmissive sheet 131. In this manner, after the sensing ray is projected to the thumb, the sensing ray is reflected by the thumb to the imaging lens 132 for being refracted. Finally, the imaged sensing ray is refracted to the optical sensing element 133, so as to calculate a relative displacement between the thumb and the finger-contact control module 13, and generate a corresponding moving signal to the microprocessor 11 for being operated. The displacement detecting and calculating manner is at least an image detecting manner or an optical detecting manner, but the part is not the subject matter of the present invention, so it is not described here.

In addition, a finger pulp of the thumb of the user may also press the key 15 on the body 20, so as to simulate functions of the left key and the right key of the mouse, and generate a key signal to the microprocessor 11 for being operated. In this manner, after receiving the moving signal and the key signal, the microprocessor 11 converts the moving signal and the key signal to the control signal corresponding to the computer host 40, and the wireless transmitter 14 transmits the control signal to the computer host 40 (as shown in FIG. 1) for being processed. In addition to simulating the left key and the right key of the mouse, the keys 15 may also simulate an Enter key and an Esc key of the keyboard, which have a function being the same as an input key on the common mouse.

The computer host 40 comprises, but not limited to, a desktop computer, a notebook computer, or various portable electronic device, such as a cell phone and a personal digital assistant (PDA). Therefore, in the present invention, after being worn on the finger of the user, the wearable input device may be operated on an extremely small operating desktop, a front end platform of the notebook computer, or a presentation without being limited by a using environment, so as to solve a disadvantage of a conventional mouse of requiring a large operating desktop. Further, the wearable input device is manipulated by using a single hand, so the device is quite conveniently carried and used, and the other free hand may do other things, such as typing and making phone calls.

In addition, the wearable input device may be removably worn on the hand of the user in a reachable range of the finger of the user, and preferably, the soft battery 30 surrounds any one of the fingers except for the thumb (for example, the fore finger), so as to be controlled by the thumb, but the present invention is not limited here. The soft battery 30 may also be designed as a watch band-like structure, and is connected to the body 20, such that the soft battery 30 is worn on the wrist of the user, and the finger moves on the light transmissive sheet 131 of the body 20 or presses the keys 15, thereby achieving the action principle as mentioned above.

The wearable input device of the present invention may be conveniently worn on the hand of the user, such that the wearable input device having a small volume is easily carried and conveniently used in cooperation with the notebook computer. The wearable input device is manipulated by a finger, such that the cursor is more flexibly moved with a higher moving accuracy. Further, the wearable input device has a small region for sensing a moving position (only a region having a size the same as the finger tip), such that the using position thereof does not require a large plane area as that of the conventional mouse.

When the device is not used, the wearable input device may be worn on the hand as a decoration, which does not occupy the space and is easily carried. Definitely, the wearable input device may be designed to be a wearing object having a larger collar range, that is, a bracelet-like or watch band-like input device, which may not only be worn as an individualized decoration, but also have functions of the input device.

What is claimed is:

1. A wearable input device, comprising:
a body, having a finger-contact control module and a wireless transmitter disposed therein, for performing a wireless signal transmission; and
a soft battery, having one end connected to the body, and the other end forming a collar range between the other end of the soft battery and the body;
wherein the soft battery surrounds a hand of a user through the collar range, and supplies an electric power for the body, such that the finger-contact control module senses a movement of an object and generates a corresponding control signal, and the wireless transmitter transmits the control signal to a computer host for manipulating a displacement of a cursor.

2. The wearable input device according to claim 1, wherein the finger-contact control module is an optical finger-contact control module, and the optical finger-contact control module further comprises:
a circuit board, disposed in the body;
a light transmissive sheet, installed on the body, for the object to contact with and move thereon;
an optical sensing element, electrically disposed on the circuit board and corresponding to the light transmissive sheet;
an imaging lens, disposed between the light transmissive sheet and the optical sensing element; and
a light emitting element, emitting a sensing ray to the light transmissive sheet;
wherein the light emitting element emits the sensing ray to the light transmissive sheet, the object reflects the sensing ray to the imaging lens, the imaged sensing ray is refracted to the optical sensing element, and the optical sensing element senses the movement of the object and generates the corresponding control signal.

3. The wearable input device according to claim 2, wherein the light transmissive sheet is a light transmissive plate, a lens, or a biconvex lens.

4. The wearable input device according to claim 2, wherein the optical sensing element is a charged coupled device (CCD) or a complementary metal-oxide semiconductor (CMOS).

5. The wearable input device according to claim 2, wherein the light emitting element is a vertically-emitting light emitting diode (LED) or a side emitting LED.

6. The wearable input device according to claim 1, wherein the finger-contact control module is a track ball device or a touch pad device.

7. The wearable input device according to claim 1, further comprising a microprocessor and a circuit board, wherein the microprocessor and the circuit board are disposed in the body, the microprocessor is electrically disposed on the circuit board, the microprocessor is used to receive the control signal transmitted by the finger-contact control module and send the control signal to the wireless transmitter for transmission.

8. The wearable input device according to claim 7, further comprising a plurality of keys, electrically disposed on the circuit board, and exposed out of the body for being pressed by the object.

9. The wearable input device according to claim 1, wherein the other end of the soft battery is joined to the body through a hook-and-loop fastener, so as to form the collar range.

10. The wearable input device according to claim 1, wherein the body has at least one fixing buckle, the soft battery has at least one buckle hole, and the fixing buckle of the body is buckled in the buckle hole of the soft battery, so as to form the collar range.
